(19) United States
(12) Patent Application Publication
(10) Pub. No.: US 2026/0145400 A1
(43) Pub. Date: May 28, 2026

(54) PREFORMED CEMENT AND FILM COMPOSITE SHEET FOR PRECURED TREADS

(71) Applicant: Continental Reifen Deutschland GmbH, Hannover (DE)

(72) Inventor: Matthew Hundelt, Rock Hill, SC (US)

(73) Assignee: Continental Reifen Deutschland GmbH, Hannover (DE)

(21) Appl. No.: 18/960,904

(22) Filed: Nov. 26, 2024

(51) Int. Cl. B29D 30/56; B29D 30/54

(52) U.S. Cl. CPC B29D 30/56; B29D 2030/544

(57) ABSTRACT

A method and system for preparing a precured tread includes providing a strip of precured tread having a tread surface and an underside surface opposite the tread surface; and applying a preformed composite sheet to the underside surface of the precured tread. The preformed composite sheet includes a top film layer and a polymer cement disposed on the top film layer. The applying the preformed composite sheet includes contacting the polymer cement with the underside surface of the precured tread. Such precured tread is then used in a tire retread process.

### TECHNICAL FIELD

The present disclosure relates generally to tires, and more particularly to retread tires, and even more particularly to a preformed cement and film composite sheet for precured treads.

### BACKGROUND

The tire retreading process involves replacing a worn tread with a new tread while reusing the remainder of the tire casing for cost-effectiveness and environmental friendliness. The conventional steps of a common retread process using precured tread includes: removal of the worn tread through a buffing process, repair of any damage to the tire casing, bonding of the precured tread to the casing using a layer of cushion gum, and curing the cushion gum with heat and pressure to ensure the new tread is securely bonded to the tire casing.

### SUMMARY

The precured tread used in conventional retread applications is commonly provided in strip-form which may be wound into a roll for dispensing the precured tread onto the tire casing during the cushion gum bonding process. To enhance the tack of the precured tread with the cushion gum during the retread process, a rubber cement may be applied to the underside of the precured tread strip. In this process, the underside of the precured tread strip may first be buffed for surface preparation and then the cement is applied to the underside of the precured tread, such as via a rolling or spraying process. The rubber cement typically contains solvents and other volatiles which are removed via a drying step. The rubber cement is still tacky at this stage, and so to prevent the precured tread from sticking to itself when wound into a roll, a polymer film is applied over the cement after drying. The precured tread with cement and polymer film is then wound into a roll and is ready to be used in the retreading process, whereby the film is removed and the tacky cement is contacted with the cushion gum during retread.

At least one problem with such an approach of preparing the precured tread is the additional steps and equipment involved in applying the cement and drying the cement to remove volatiles. For example, such process steps may demand additional equipment with precise controls for applying the desired amount of cement to the underside of the precured tread strip. Moreover, the drying step also may demand additional equipment and controls to handle the volatile organic compounds and other gases removed from the cement, such as vapor recovery units, ventilation and exhaust systems, scrubbers, oxidizers, condensers, or the like.

At least one aspect of the present disclosure solves one or more problems associated with conventional precured tread by providing a preformed cement and film composite sheet that can be applied to the underside of the prepared precured tread without the need for at least the separate cementing and drying steps.

According to an aspect, a method of preparing a precured tread includes: providing a strip of precured tread having a tread surface and an underside surface opposite the tread surface; applying a preformed composite sheet to the underside surface of the precured tread; wherein the preformed composite sheet includes a top film layer and a polymer cement disposed on the top film layer, and wherein the applying the preformed composite sheet includes contacting the polymer cement with the underside surface of the precured tread.

According to an aspect, a system for preparing a precured tread includes: a source of precured tread provided as a strip and having a tread surface and an underside surface opposite the tread surface; an applicator downstream of the source, the applicator including a source of a preformed composite sheet, the preformed composite sheet including a top film layer and a polymer cement disposed on the top film layer, wherein the applicator is configured to apply the preformed composite sheet to the precured tread by contacting the polymer cement with the underside surface of the precured tread.

The following description and the annexed drawings set forth certain illustrative embodiments according to the present disclosure. These embodiments are indicative, however, of but a few of the various ways in which the principles of the invention may be employed. Other objects, advantages and novel features according to aspects of the present disclosure will become apparent from the following detailed description when considered in conjunction with the drawings.

### BRIEF DESCRIPTION OF THE DRAWINGS

The annexed drawings, which are not necessarily to scale, show various embodiments according to the present disclosure.

FIG. 1 depicts a conventional process for applying a cement to an underside of a precured tread.

FIG. 2 depicts an exemplary process according to the present disclosure of applying a preformed composite sheet with polymer cement to the underside surface of a precured tread.

FIG. 3 illustrates a segment of an exemplary preformed composite sheet having a top film layer and a polymer cement disposed thereon according to an embodiment of the present disclosure.

FIG. 4 illustrates a segment of another exemplary preformed composite sheet having a top film layer and a polymer cement disposed thereon according to another embodiment of the present disclosure.

FIG. 5 is a cross-sectional view illustrating an exemplary precured tread with the preformed composite sheet applied to the underside of the precured tread.

FIG. 6 is a cross-sectional view illustrating an exemplary retread tire casing using the preformed tread in FIG. 5.

### DETAILED DESCRIPTION

The principles and aspects according to the present disclosure have particular application to precured treads, and thus will be described herein mainly in this context. It is understood, however, that the principles and aspects of the present disclosure may be applicable to other types of treads or tires for other applications, or to other elastomeric articles in general, when desirable to provide one or more advantages of the material(s) and/or construction(s) described herein.

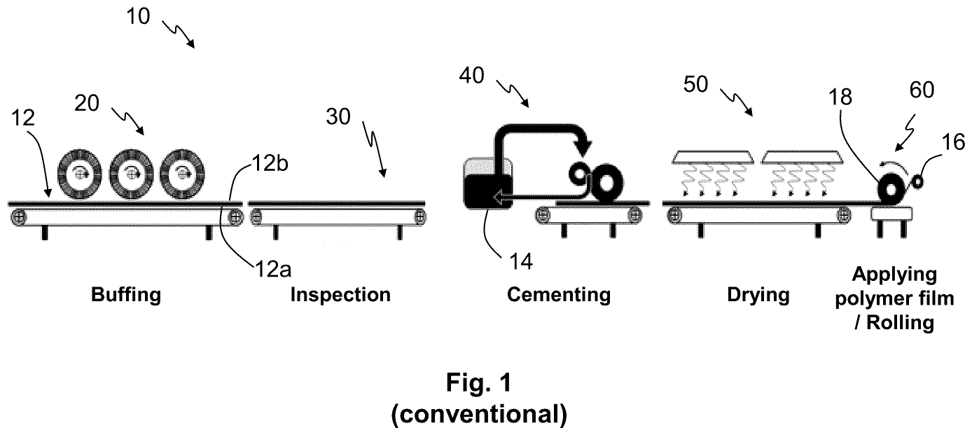

FIG. 1 depicts a conventional process 10 for applying a rubber cement to an underside of a precured tread 12. As shown, the precured tread 12 used in conventional retread applications is commonly provided in strip-form with a tread surface 12a and an underside surface 12b which is applied to a retread tire casing with a bonding layer commonly referred to as cushion gum.

At an initial step of preparing the precured tread, a buffing process 20 prepares the underside surface 12b of the precured tread by using buffers, such as buffing wheels.

After buffing 20, the underside surface 12b of the precured tread is inspected at step 30.

The cementing step 40 applies a rubber cement 14 to the underside surface 12b of the precured tread 12. This rubber cement 14 is used to enhance the tack of the precured tread 12 with the cushion gum during the retread process. The rubber cement 14 is conventionally solvated with a solvent, such as heptane, to provide a consistency for applying to the precured tread 12. This solvated rubber cement is relatively flowable and may have a solids content of 25% or less. As such, the application of the solvated rubber cement may include such processes as rolling or spraying.

A heated drying step 50 is used to remove the solvents or other volatiles from the rubber cement. This may include suitable drying equipment, such as heaters and/or air circulation equipment (e.g., fans). The drying step 50 also may demand additional solvent extraction and recovery equipment.

Because the rubber cement 14 is still tacky after the drying step 50, a polymer film 16 is applied over the rubber cement so to prevent the precured tread 12 from sticking to itself when wound into a roll 18. This roll of precured tread with cement and polymer film is then ready to be used in the retreading process, whereby the film 16 is removed and the tacky cement 14 is contacted with the cushion gum during retread.

At least one problem with such a conventional process 10 of preparing the precured tread is the additional steps and equipment involved in applying the cement and drying the cement to remove volatiles. For example, such process steps may demand additional equipment with precise controls for applying the desired amount of cement to the underside of the precured tread strip during the cementing process 40. Moreover, the drying step 50 also may demand additional equipment and controls to provide such drying (e.g., heating and/or air circulation) and also handle the volatile organic compounds and other gases removed from the cement, such as vapor recovery units, ventilation and exhaust systems, scrubbers, oxidizers, condensers, or the like.

At least one aspect of the present disclosure solves one or more problems associated with conventional precured tread processes by providing a preformed cement and film composite sheet that can be applied to the underside of the prepared precured tread without the need for at least the separate cementing and drying steps 40, 50.

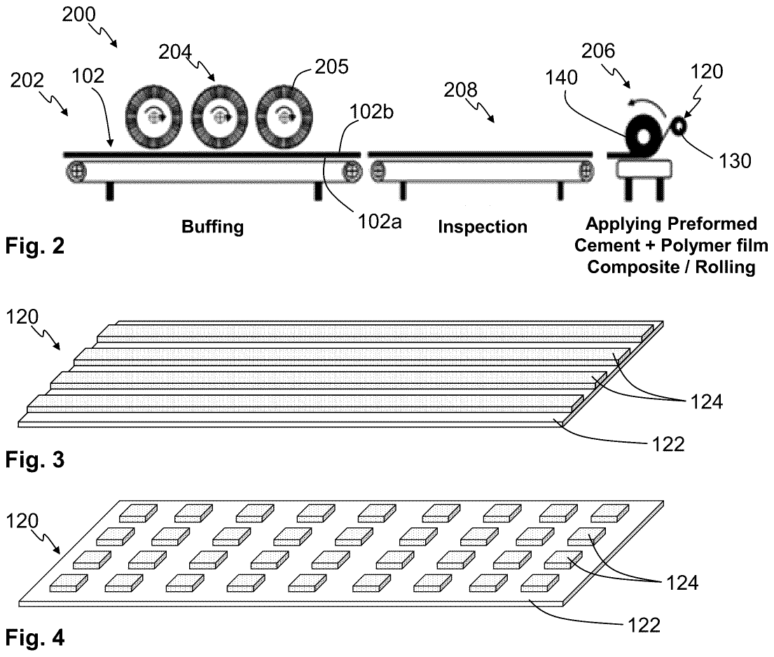

FIG. 2 shows an exemplary process 200 of preparing a precured tread according to the present disclosure. The method 200 includes: (i) providing 202 a strip of precured tread 102 having a tread surface 102a and an underside surface 102b opposite the tread surface; and (ii) applying 206 a preformed composite sheet 120 to the underside surface 102b of the precured tread 102. According to an aspect of the present disclosure, the preformed composite sheet 120 includes a top film layer 122 and a polymer cement 124 disposed on the top film layer 122, as illustrated in the embodiments of FIGS. 3 and 4, for example. Accordingly, the applying 206 the preformed composite sheet 120 to the precured tread 102 includes contacting the polymer cement 124 with the underside surface 102b of the precured tread 102, which enables the polymer cement to be transferred to the precured tread for subsequent application to a cushion layer on a tire casing during subsequent retread processing.

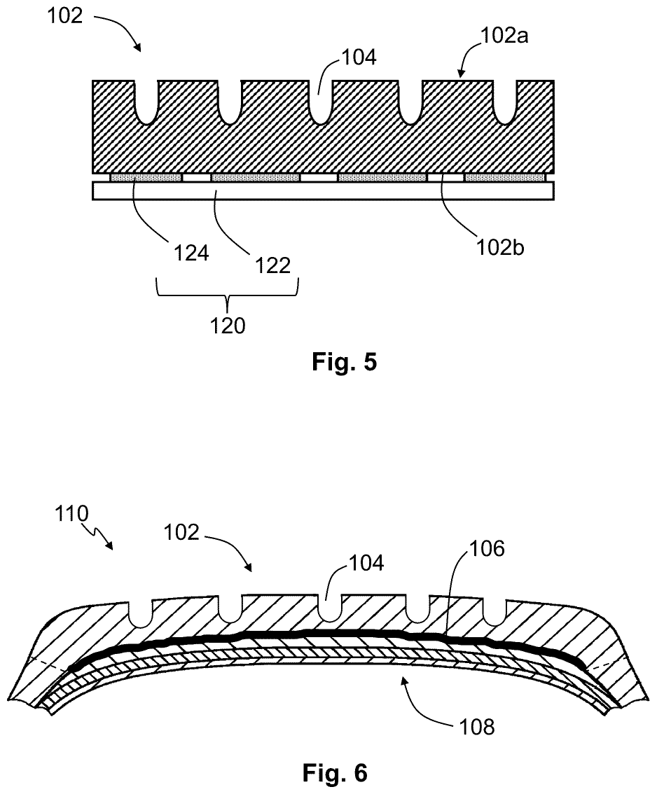

The strip of precured tread 102 may have any suitable configuration and may be formed from any suitable rubber mixture as desired for the particular retread application. Generally, the precured tread 102 is formed from a rubber mixture that is cured (vulcanized) to form the tread surface 102a and the underside surface 102b opposite the tread surface. The tread surface 102a generally may include longitudinal grooves 104 along a length the strip (FIG. 5) which form circumferential grooves 104 when applied to the tire casing during the retread (FIG. 6). Such tread pattern also can include transverse grooves forming profile blocks; sipes; or any other suitable tire tread feature. The length of the precured tread strip 102 generally is sufficiently long to continuously wrap around the circumference of the tire being retread.

The exemplary process 200 may further include buffing 204 the underside surface 102b of the precured tread 102 prior to the applying 206 the preformed composite sheet 120. The buffing process 204 prepares the underside surface 102b of the precured tread for retreading by providing a suitable surface texture and/or evenness. The buffing 204 generally includes removal of material from the underside surface 102b via suitable buffers 205, such as wire brushes or the like. Accordingly, after such buffing 204, the applying 206 of the preformed composite sheet 120 may include contacting the polymer cement 124 with the buffed underside surface 102b of the precured tread. Alternatively, the process 200 may not have a buffing step 204 as the precured tread 102 could be delivered to a retread facility in an already prepared form, for example with the underside surface 102b of the precured tread already buffed.

Generally, the buffed underside surface 102b may be cleaned via vacuums, solutions, or the like and no further materials remain on the underside surface 102b of the precured tread 102. As such, the polymer cement 124 of the composite sheet 120 may directly contact the rubber at the underside surface 102b of the precured tread 102. It is understood, however, that such process 200 could be adapted to include intermediate steps, such as adding materials like suitable coupling agents/bonding agents (e.g., in liquid form) to the underside surface 102b to interact with the polymer cement 124. Accordingly, it understood that such terms like contacting, applying, or the like may include direct engagement or indirect engagement unless expressly noted otherwise to the contrary. Accordingly, “contacting the polymer cement with the underside surface of the precured tread” is understood to be satisfied even when an intermediate material or layer is interposed between the rubber of the precured tread and the polymer cement.

After the buffing process 204 and/or prior to the application 206 of the preformed composite sheet 120, the process may further include intermediate steps such as inspecting 208 the underside surface 102b to ensure that the surface has proper surface roughness, cleanliness, evenness, lack of defects, or the like. Such processes of providing 202, buffing 204, and inspecting 208 may be as conventional.

The applying 206 of the preformed composite sheet 120 to the underside surface 102b of the precured tread 102 may be performed in any suitable manner. For example, the preformed composite sheet 120 may be provided in a roll 130, and is unrolled during the applying 206 to the underside surface 102b of the precured tread. The precured tread 102 with preformed composite sheet 120 may itself be rolled into a roll 140 for transferring this assembly to the retread process. The roller that winds the tread/sheet assembly into roll 140 may be downstream of the applicator that applies 206 the preformed composite sheet 120 to the precured tread 102, or may the preformed composite sheet 120 may be applied to the precured tread 102 as it is being rolled, as shown.

As shown in the illustrated embodiment, such an exemplary process 200 may eliminate at least the solvated cementing step 40 and the drying step 50 via heaters and/or air circulators of the conventional process. As such, the system and method according to the present disclosure may be devoid of such steps and associated equipment, such as drying steps and associated equipment upstream of the applying 206 process, which also may eliminate solvent extraction equipment.

Turning to FIGS. 3 and 4, exemplary embodiments of the preformed composite sheet 120 including top film layer 122 and polymer cement 124 disposed on the top film layer 122 are shown. The polymer cement 124 may be applied to the film layer 122 in any suitable manner and in any suitable construction. For example, the polymer cement 124 may be applied via a rolling or spraying process, with optional additional steps to transform the polymer cement 124 into its final form in the preformed composite sheet 120. As shown, the construction of the polymer cement 124 may include, for example, discrete units that are spaced from each other, such as elongated strips as shown in FIG. 3 and/or an array of dots as shown in FIG. 4. These discrete units may be applied via an applicator such as a roller, for example. Alternatively, the polymer cement 124 may form a continuous layer across the film 122, such as via a spraying process, for example. In exemplary embodiments, the top film layer 122 is a flexible film having a thickness in a range from about 0.05 mm to 0.3 mm, more particularly from about 0.1 mm to about 0.2 mm. The polymer cement 124 on the top film layer 122 may have a thickness from about 0.5 mm to about 3 mm, more particularly from about 1 mm to 2 mm, for example.

The polymer cement 124 is suitable for assisting tacking of the precured tread 102 to a layer of cushion gum 106 on a tire casing 108 during a retread process without negatively affecting bonding of the precured tread 102 to the tire casing 108 via curing of the cushion gum 106 (FIG. 6). The polymer cement 124 may have any suitable composition to provide such function. As used herein, however, the term polymer cement means that the cement includes at least one polymer that forms the binder/matrix of the cement and which may include further additional additives as understood by those skilled in the art.

The amount of polymer used as the matrix binder may depend on the type of polymer and amount of additives and/or desired performance for the cement. For example, the polymer(s) forming the matrix may constitute from about 25 wt. % to about 80 wt. % based on total weight of the polymer cement, more particularly from about 40 wt. % to about 60 wt. %. The polymer matrix may be in an un-crosslinked state when the cement 124 is disposed on the preformed composite sheet 120 and is thereafter cured during the curing of the cushion gum 106 when bonding the precured tread 102 to the tire casing 108. The polymer(s) used for the matrix may include elastomer(s) or rubber(s) to form a ruber mixture with the additives to form the cement 124. The polymer matrix of the rubber mixture generally will be formed from a majority of rubber/elastomer material(s) as opposed to other types of non-elastomer base polymer(s) to provide elastic properties, for example at least 80 wt. %, or at least 90 wt. % or more rubber/elastomer material(s) forming the polymer matrix of the rubber mixture.

The polymer matrix of the polymer cement 124 may include, but is not limited to, natural rubber (NR), epoxidized natural rubber (ENR), polybutadiene rubber (BR), acrylonitrile butadiene rubber (NBR), carboxylated nitrile rubber (XNBR), (partially) hydrogenated nitrile rubber (HNBR), styrene butadiene rubber (SBR), carboxylated styrene-butadiene rubber (XSBR), styrene/ethylene-butylene/styrene-based (SEBS), ethylene propylene monomer (EPM), ethylene propylene diene monomer (EPDM), chloroprene rubber (CR), isoprene rubber (IR), butyl rubber (IIR), bromobutyl rubber (BIIR), chlorobutyl rubber (CIIR), chlorinated polyethylene (CPE), chlorosulfonated polyethylene (CSM), alkylated chlorosulfonated polyethylene (ACSM), polyepichlorohydrin rubbers (CO; ECO; ETER), ethylene-vinyl acetate rubber (EVA), acrylate rubber (ACM), ethylene-acrylate rubber (AEM), silicone rubber (MQ, VMQ, PVMQ, FVMQ), fluorine rubber (FKM), fluorinated methylsilicone rubber (MFQ), perfluorinated propylene rubber (FFPM), perfluorocarbon rubber (FFKM), thermoplastic elastomers (TPE), thermoplastic vulcanizates (TPV), thermoplastic polyurethanes (TPU), polyolefin elastomers (POE), polyvinylchloride (PVC), and/or polyurethane (PU), and/or the like, or blends thereof.

The additives in the composition are compounded relative to the total base polymer content of the composition, and as such may be represented in parts per hundred (phr), which means parts by weight per 100 parts by weight of the base/matrix polymer(s). Such additives may include, and are not limited to, vulcanizing agents (e.g., sulfur or peroxides), accelerators, retardants to prevent an unduly quick cure, activators, antidegradants, tackifiers, processing aids, reinforcing agents (such as carbon black or silica), other mineral fillers, or the like.

In exemplary embodiments, to provide sufficient tackiness of the rubber cement, the polymer cement may include one or more tackifiers which may be present in an amount from about 0 phr to 25 phr, more particularly from about 5 phr to about 25 phr as an example. Such tackifier(s) may include hydrocarbon resins, such as C5 (e.g., aliphatic) resins, C9 (e.g., aromatic) resins, and C5/C9 hybrids, which are derived from petroleum feedstocks; terpene resins, derived from natural sources like pine trees; phenolic resins, such as resorcinol-formaldehyde resins; rosin and rosin esters, which are natural resins; or the like. Other tackifiers may include polymeric types, such as polyisobutylene resin, as well as liquid or semi-solid tackifiers designed for specific processing requirements. The selection of a tackifier is influenced by factors such as compatibility with the rubber type, processing needs, and the end-use application to provide suitable adhesion. It is understood, however, that depending on the type of polymer (e.g,. rubber) used for the polymer cement, the cement may have sufficient tackiness without the addition of these added tackifiers.

In exemplary embodiments, the polymer cement 124 is a rubber mixture that has the same composition as the cushion gum 106 except with the addition of one more tackifiers. This enables the polymer cement 124 to not act as a contaminant in the retread bonding process. In embodiments, the one or more additional tackifiers include aliphatic C5 resin(s). In embodiments, the one or more additional tackifier(s) are added into the cushion gum rubber mixture in an amount from 0 phr to 25 phr, more particularly from about 5 phr to about 25 phr, to form the polymer cement.

To be suitably secured on the top film layer 122 as the preformed composite sheet 120 is transported and/or applied to the precured tread 102, the polymer cement 124 may have a relatively high solids content and is not flowable so as to not run off the film 122. For example, the solids content of the polymer cement 124 may be in a range from about 80 wt. % to about 100 wt. %.

To preclude the demand for solvent extraction equipment, the polymer cement 124 may be essentially free of solvents. This means that the polymer cement 124 may have less than 5 wt. % solvent, more particularly less than 1 wt. % solvent or about 0.1 wt. % solvent or less.

To help prevent contamination with the cushion gum 106, the polymer cement 124 and/or the film 122 may be essentially free of silicone, such as less than 1 wt. % silicone or about 0.1 wt. % silicone or less.

The top film layer 122 essentially serves as a carrier for the polymer cement 124 and also serves as a barrier/cover for the polymer cement 124, especially when the precured tread 102 is wound into a roll. To enable such rolling, the top film layer 122 may be flexible. Such construction of the film 122 covering the polymer cement 124 which is sandwiched between the underside surface 102b and film 122 is illustrated in FIG. 5 as an example.

In exemplary embodiments, the top film layer 122 is a polymer sheet which may be made from any suitable polymer, such as flexible polymers. For example, the polymer sheet 122 may be low-density polyethylene (LDPE) (e.g., 0.91-0.94 g/cc), high-density polyethylene (HDPE) (e.g., 0.95-0.97 g/cc), polypropylene (PP), ethylene vinyl acetate (EVA), or the like.

The polymer film may have a thickness that provides suitable flexibility. For example, the flexible polymer film may have a thickness in a range from about 0.05 mm to 0.3 mm, more particularly from about 0.1 mm to about 0.2 mm.

In exemplary embodiments, the top film layer 122 is intended to be removed prior to applying the precured tread 102 with the polymer cement 124 to the cushion gum 106 during the retread process. As such, the top film layer 122 has a surface that enables the polymer cement 124 to stick when in the preformed composite sheet 120, but also enables the film 122 to be peeled off while retaining the polymer cement 124 to the underside surface of the precured tread 102. In other words, the top film layer 122 may provide a bonding force with the polymer cement 124 that is less than a bonding force between the polymer cement 124 and the underside surface 102b of the precured tread 102, thereby allowing the top film layer 122 to be removed without removing the polymer cement 124 from the precured tread 102.

FIG. 6 illustrates a portion of a retread tire 110 using the prepared precured tread 102 in accordance with the method 200 and as illustrated in FIG. 5. As is conventional, the tire casing 108 may include carcass ply or plies, which may be made of fabric or steel cords embedded in rubber. Beneath the previously removed tread, the casing 108 may include belts which remain in place, reinforcing the casing and enhancing its resistance to deformation and punctures. The sidewalls are intact along the lateral portions of the casing 108, connecting the structural components and providing support to the outer edges. The beads (not shown), located at the inner circumferential edges of the casing 108, ensure secure engagement with the wheel rim and maintain the seal for air retention. The inner liner, positioned on the innermost surface of the casing 108, acts as a barrier to contain air pressure. The shoulder regions, which form the transition between the sidewalls and the tread area/crown, also may be buffed. In this manner, when the worn/old tread is removed from the tire casing, the area of the tread crown, as well as the shoulder regions (part of the buffing profile), are roughened during the buffing process to create a texture that increases surface area and allows the cushion gum 106 to flow into these crevices and increase bonding. This casing structure 108 forms the basis for adhering the cushion gum 106 and precured tread 102 in the tire retreading process. The polymer cement 124 of the precured tread 102 may intermix with the cushion gum 106 and thus is shown as such in the illustrated embodiment.

Such a retread process, therefore, may include the steps; (i) providing a buffed tire casing 108 or buffing the worn tread from a tire to provide the tire casing 108; (ii) applying a cushion gum 106 around the circumference of the buffed tire casing 108; (iii) providing the precured tread 102 with preformed composite sheet 120 manufactured according to the method 200; (iv) removing the top film layer 122 from the precured tread 102 while retaining the tacky polymer cement 124 on the underside surface 102b of the precured tread 102; (v) applying the precured tread 102 to the tire casing 108 by contacting the tacky polymer cement 124 with the cushion gum 106, whereby the cushion gum 106 and polymer cement 124 may intermix; and (vi) bonding the precured tread 102 to the tire casing 108 by curing the cushion gum 106 using heat and/or pressure.

Exemplary methods and constructions for a preformed composite sheet, preformed tread with such composite sheet, and retread tire using such preformed tread have been described herein.

According to an aspect, a method of preparing a precured tread includes: providing a strip of precured tread having a tread surface and an underside surface opposite the tread surface; applying a preformed composite sheet to the underside surface of the precured tread; wherein the preformed composite sheet includes a top film layer and a polymer cement disposed on the top film layer, and wherein the applying the preformed composite sheet includes contacting the polymer cement with the underside surface of the precured tread.

According to an aspect, a system for preparing a precured tread includes: a source of precured tread provided as a strip and having a tread surface and an underside surface opposite the tread surface; an applicator downstream of the source, the applicator including a source of a preformed composite sheet, the preformed composite sheet including a top film layer and a polymer cement disposed on the top film layer, wherein the applicator is configured to apply the preformed composite sheet to the precured tread by contacting the polymer cement with the underside surface of the precured tread.

Exemplary embodiment(s) may combine one or more features of the foregoing aspects with each other in any suitable manner; and/or exemplary embodiment(s) may include one or more of the following additional features combined with any of the foregoing or following aspects, in which one or more of these additional features may be combined separately or in any suitable combination with each other.

In exemplary embodiment(s), the method and/or system further includes: buffing the underside surface of the precured tread prior to the applying the preformed composite sheet; wherein the applying the preformed composite sheet includes contacting the polymer cement with the buffed underside surface of the precured tread.

In exemplary embodiment(s), the method and/or system further includes: winding the strip of precured tread with the composite sheet into a roll.

In exemplary embodiment(s), the method and/or system is devoid of a heated drying and/or air-circulated drying step between the applying and the winding; more particularly, being devoid of a dryer between the buffer and applicator; and/or is devoid of solvent extraction equipment.

In exemplary embodiment(s), the method and/or system is devoid of a polymer cement applicator, such as a solvated polymer cement applicator.

In exemplary embodiment(s), the method and/or system includes the preformed composite sheet is provided in a roll, and is unrolled during the applying to the buffed underside surface of the precured tread.

In exemplary embodiment(s), the method and/or system includes the polymer cement comprises a rubber mixture.

In exemplary embodiment(s), the method and/or system includes the rubber mixture of the polymer cement includes one or more tackifier(s) in an amount of up to 25 phr, more particularly from 5 phr to 25 phr.

In exemplary embodiment(s), the method and/or system includes the rubber mixture is essentially free of solvent.

In exemplary embodiment(s), the method and/or system includes the rubber mixture is free of silicone.

In exemplary embodiment(s), the method and/or system includes the polymer cement is disposed on the top film layer in an array of discrete spaced apart units; more particularly, wherein the polymer cement is disposed on the top film layer in elongated strips and/or the polymer cement is disposed on the top film layer in an array of dots.

In exemplary embodiment(s), the method and/or system includes the polymer cement is disposed on the top film layer as a continuous layer.

In exemplary embodiment(s), the method and/or system includes the polymer cement is disposed on the top film layer in a thickness range from 1 mm to 2 mm.

In exemplary embodiment(s), the method and/or system includes the polymer cement is suitable for assisting tacking of the precured tread to a layer of cushion gum on a tire casing in a retread process without negatively affecting bonding of the precured tread to the tire casing via curing of the cushion gum.

In exemplary embodiment(s), the method and/or system includes that a bonding force between the polymer cement and the top film layer is less than a bonding force between the polymer cement and the underside of the precured tread, thereby allowing the top film layer to be removed without removing the polymer cement from the precured tread.

In exemplary embodiment(s), the method and/or system includes that the top film layer is a polymer sheet.

In exemplary embodiment(s), the method and/or system includes that the polymer sheet is a low-density polyethylene, high-density polyethylene, polypropylene, or ethylene vinyl acetate sheet.

In exemplary embodiment(s), the method and/or system includes that the top polymer sheet has a thickness in a range from 0.1 mm to 0.2 mm.

According to another aspect, a method and/or system of retreading a tire, includes: providing a buffed tire casing; applying a cushion gum to the buffed tire casing; providing the precured tread with preformed composite sheet manufactured according to the method of any of the foregoing; removing the top film layer from the precured tread while retaining the polymer cement on the underside surface of the precured tread; applying the precured tread to the tire casing by contacting the polymer cement with the cushion gum; bonding the precured tread to the tire casing by curing the cushion gum using heat and/or pressure.

In exemplary embodiment(s), the method and/or system includes the polymer cement is a rubber mixture that has the same composition as the cushion gum except with the addition of one or more tackifier(s); more particularly wherein the one or more additional tackifier(s) include aliphatic resin(s); and/or more particularly wherein the one or more additional tackifier(s) are added into the rubber mixture of the polymer cement in an amount of up to 25 phr, more particularly from 5 phr to 25 phr.

In exemplary embodiment(s), the method and/or system includes a roller downstream of the applicator that applies the preformed composite sheet, the roller being configured to roll the precured tread together with the preformed composite sheet into a roll.

In exemplary embodiment(s), the method and/or system includes the applicator including a roller in which the preformed composite sheet is applied to the precured tread as the precured tread is being rolled.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. Thus, while a particular feature may have been described with respect to only one or more of several embodiments, such feature may be combined with one or more other features of the other embodiments, separately or in any combination. The same may also be varied in many ways. Such variations are not to be regarded as a departure from the disclosure, and all such modifications are intended to be included within the scope of the disclosure. as may be desired and advantageous for any given or particular application.

Any background information contained in this disclosure is to facilitate a better understanding of the various aspects described herein. It should be understood that any such background statements are to be read in this light, and not as admissions of prior art. Likewise, the description and examples are presented herein solely for the purpose of illustrating the various embodiments of the disclosure and should not be construed as a limitation to the scope and applicability of the disclosure.

Transitional language such as “including,” “comprising,” “having,” “containing,” “involving,” or variations thereof, is intended to be broad and encompass the subject matter listed thereafter, equivalents, and additional subject matter not recited, i.e., to be open-ended and meaning including but not limited to.

Use of “a” or “an” are employed in this disclosure to describe elements and components of the embodiments herein. This is done merely for convenience and to give a general sense of concepts according to the disclosure. This description should be read to include one or at least one and the singular also includes the plural unless otherwise stated.

The phrase “and/or” as used in this disclosure should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

The phrases “at least one of [A], [B] and [C];” “at least one of [A], [B] or [C];” “one or more of [A], [B] and [C]”; or “one or more of [A], [B] or [C]” are all synonymous with the phrase “and/or” and are used to mean “one, or more, or all” unless clearly indicated to the contrary. Thus, as a non-limiting example, this could mean (1) A only, (2) B only, (3) C only, (4) A and B, (5) A and C, (6) B and C, or (7) all of A, B and C. Other elements may optionally be present other than the elements specifically identified whether related or unrelated to those elements specifically identified unless clearly indicated to the contrary—e.g., by reciting a closed group of alternatives, such as via conventional “Markush grouping” by stating “selected from the group consisting of [A], [B], and [C].”

The word “or” as used in this disclosure should be understood as being inclusive and not exclusive. For example, when separating items in a list, “or” or “and/or” shall be interpreted as being inclusive, i.e., the inclusion of at least one, but also including more than one, of a number or list of elements, and, optionally, additional unlisted items. For example, a condition A or B is satisfied by anyone of the following: A is true (or present) and B is false (or not present), A is false (or not present) and B is true (or present), and both A and B are true (or present). Only terms clearly indicating exclusivity should be interpreted as indicating exclusive alternatives (i.e. “one or the other but not both”), such as “either,” “only one of,” or “exactly one of.” In other words, such terms of exclusivity refer to the inclusion of exactly one element of a number or list of elements.

Any references to “one embodiment” or “an embodiment” as used herein is understood to mean that a particular element, feature, structure, or characteristic described in connection with the embodiment is included in at least one embodiment. The appearances of the phrase “in one embodiment” in various places in the specification are not necessarily referring to the same embodiment.

The word “exemplary” is used herein to mean “serving as an example or illustration.” Any aspect or design described herein as “exemplary” is not necessarily to be construed as preferred or advantageous over other aspects or designs. Likewise, the phrases “particularly,” “preferably,” or the like as used in this disclosure may refer to an element or value that provides advantage(s) in some embodiment(s), however is not intended to limit the scope of the disclosure to those “particular” or “preferable” features.

The example(s), if any, are for the purpose of illustrating the nature of some of the embodiment(s) and/or aspect(s) of the present disclosure and are not intended as a limitation on the scope thereof. Along these lines, such example(s) may include exemplary ingredients according to certain embodiment(s) of the present disclosure, and also may specifically exclude certain other ingredient(s) according to certain embodiment(s) of the present disclosure. Therefore, it is to be understood that the listing of certain ingredient(s) or class(es) of ingredients in the disclosure which are absent in the example(s) of the disclosure can mean an express exclusion of such ingredient(s) or class(es) of ingredients as if explicitly stated such that the inventor(s) have possession of such exclusion(s). It is understood, of course, that the absence of ingredient(s) according to certain embodiment(s) illustrated in the example(s) is not a limitation on all embodiment(s) of the disclosure, and so some embodiment(s) may include the absent ingredient(s), unless clearly indicated to the contrary.

It is to be understood that all values, ranges, ratios or the like as described in this disclosure may be combined in any manner. In addition, it is to be understood that a concentration or amount or value range listed in this disclosure is intended to include any and every concentration or amount or value within the range, including the end points, as if each value within the range has been expressly stated, and thus these values are incorporated herein by reference. For example, “a range of from 1 to 10” is to be read as indicating each and every possible number along the continuum between about 1 and about 10. Thus, even if specific data points within the range, or even no data points within the range, are explicitly identified or refer to only a few specific data points, it is to be understood that the inventor(s) appreciate and understand that any and all data points within the range are to be considered to have been specified, and that inventor(s) have possession of the entire range and all points within the range, which are hereby incorporated herein by reference.

In addition, each numerical value used in this disclosure should be read once as modified by the term “about” (unless already expressly so modified), and then read again as not so modified unless otherwise indicated in context. The term “about” as used herein refers to any value which lies within the range defined by a variation of up to ±10% of the stated value, for example, ±10%, ±9%, ±8%, ±7%, ±6%, ±5%, ±4%, ±3%, ±2%, ±1%, ±0.01%, or ±0.0% of the stated value, as well as values intervening such stated values. When the term “about” is used in describing a value or an end-point of a range, the disclosure should be understood to include the specific value or end-point referred to.

It is to be understood that terms such as “top,” “bottom,” “left,” “right,” “front,” “rear,” or the like may refer to an arbitrary frame of reference, rather than to the ordinary gravitational frame of reference. Likewise, spatially relative terms, such as “inner”, “adjacent”, “outer,” “beneath,” “below,” “lower,” “above,” “upper,” or the like, may be used herein for ease of description to describe one element or feature's relationship to another element(s) or feature(s) as illustrated in the figures. Spatially relative terms may be intended to encompass different orientations of the article in use or operation in addition to the orientation depicted in the figures. For example, if the article in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Terms such as first, second, third, etc. may be used herein to describe various elements, components, regions, layers and/or sections, in which it is understood that these elements, components, regions, layers and/or sections should not be limited by these terms unless stated otherwise. In addition, terms such as “first,” “second,” and other numerical terms when used herein do not imply a sequence or order unless clearly indicated by the context. Thus, a first element, component, region, layer or section discussed herein could be termed a second element, component, region, layer or section without departing from the teachings of this disclosure.

Although the invention has been shown and described with respect to a certain embodiment or embodiments, it is apparent that equivalent alterations and modifications will occur to those having ordinary skill in the art upon the reading and understanding this disclosure, and such modifications are intended to be included within the scope of this disclosure as defined in the claims. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the disclosure.

1. A method of preparing a precured tread, comprising:
providing a strip of precured tread having a tread surface and an underside surface opposite the tread surface;
applying a preformed composite sheet to the underside surface of the precured tread,
wherein the preformed composite sheet includes a top film layer and a polymer cement disposed on the top film layer, and
wherein the applying the preformed composite sheet includes contacting the polymer cement with the underside surface of the precured tread.

2. The method according to claim 1, further comprising:
buffing the underside surface of the precured tread prior to the applying the preformed composite sheet;
wherein the applying the preformed composite sheet includes contacting the polymer cement with the buffed underside surface of the precured tread.

3. The method according to claim 1, further comprising:
winding the strip of precured tread with the composite sheet into a roll.

4. The method according to claim 3, wherein:
the method is devoid of a heated drying and/or air-circulated drying step between the applying and the winding.

5. The method according to claim 1, wherein:
the preformed composite sheet is provided in a roll, and is unrolled during the applying to the buffed underside surface of the precured tread.

6. The method according to claim 1, wherein:
the polymer cement comprises a rubber mixture.

7. The method according to claim 6, wherein:
the rubber mixture of the polymer cement includes one or more tackifier(s) in an amount of up to 25 phr.

8. The method according to claim 6, wherein:
the rubber mixture is essentially free of solvent.

9. The method according to claim 6, wherein:
the rubber mixture is free of silicone.

10. The method according to claim 1, wherein:
the polymer cement is disposed on the top film layer in an array of discrete spaced apart units; or
the polymer cement is disposed on the top film layer as a continuous layer.

11. The method according to claim 1, wherein:
the polymer cement is disposed on the top film layer in a thickness range from 1 mm to 2 mm.

12. The method according to claim 1, wherein:
the polymer cement is suitable for assisting tacking of the precured tread to a layer of cushion gum on a tire casing in a retread process without negatively affecting bonding of the precured tread to the tire casing via curing of the cushion gum; and/or
a bonding force between the polymer cement and the top film layer is less than a bonding force between the polymer cement and the underside of the precured tread, thereby allowing the top film layer to be removed without removing the polymer cement from the precured tread.

13. The method according to claim 1, wherein:
the top film layer is a polymer sheet.

14. The method according to claim 13, wherein:
the polymer sheet is a low-density polyethylene, high-density polyethylene, polypropylene, or ethylene vinyl acetate sheet.

15. The method according to claim 1, wherein:
the top polymer sheet has a thickness in a range from 0.1 mm to 0.2 mm.

16. A method of retreading a tire, comprising:
providing a buffed tire casing;
applying a cushion gum to the buffed tire casing;
providing the precured tread with preformed composite sheet manufactured according to the method of claim 1;
removing the top film layer from the precured tread while retaining the polymer cement on the underside surface of the precured tread;
applying the precured tread to the tire casing by contacting the polymer cement with the cushion gum;
bonding the precured tread to the tire casing by curing the cushion gum using heat and/or pressure.

17. The method according to claim 15, wherein
the polymer cement is a rubber mixture that has the same composition as the cushion gum except with the addition of one or more tackifier(s);
wherein the one or more additional tackifier(s) are added into the rubber mixture of the polymer cement in an amount of up to 25 phr.

18. The method according to claim 1, wherein: the providing the strip of precured tread is from a source;
an applicator is provided downstream of the source, the applicator including a source of the preformed composite sheet,
wherein the applicator is configured to perform the applying of the preformed composite sheet to the precured tread by contacting the polymer cement with the underside surface of the precured tread.

19. The method according to claim 18,
wherein a roller is provided downstream of the applicator, the roller being configured to roll the precured tread together with the preformed composite sheet into a roll; or
wherein the applicator includes a roller in which the preformed composite sheet is applied to the precured tread as the precured tread is being rolled.

20. The method according to claim 18,
wherein there is no dryer between the buffer and the applicator; and/or
wherein there is no solvent extraction equipment used in the method; and/or
wherein there is no polymer cement applicator used in the method.

21. (canceled)
